(19) United States
(12) Patent Application Publication
(10) Pub. No.: US 2022/0091449 A1
(43) Pub. Date: Mar. 24, 2022

(54) ARRAY SUBSTRATE AND METHOD FOR MANUFACTURING THE SAME AND DISPLAY DEVICE

(71) Applicant: HKC Corporation Limited, Shenzhen City (CN)

(72) Inventors: Xiaodong Wang, Shenzhen City (CN); Chongwei Tang, Shenzhen City (CN)

(73) Assignee: HKC Corporation Limited

(21) Appl. No.: 17/228,166

(22) Filed: Apr. 12, 2021

(30) Foreign Application Priority Data
Sep. 23, 2020 (CN) 2020110077683

(51) Int. Cl. G02F 1/1337; G02F 1/1339; G02F 1/1343

(52) U.S. Cl. CPC G02F 1/1337; G02F 1/13439; G02F 1/1339

(57) ABSTRACT

An array substrate and a method for manufacturing an array substrate, and a display device. The array substrate includes: an underlay substrate; a blocking wall disposed in a sealing area on the underlay substrate; and an alignment film disposed in a display area on the underlay substrate. The blocking wall is located in the sealing area at inner side of a sealant bonding portion. The blocking wall is configured to prevent the alignment film in the display area from diffusing to the sealant bonding portion. The blocking wall includes a first blocking wall and a second blocking wall. The first blocking wall includes a plurality of first blocking members arranged spaced away. The second blocking wall is located between the first blocking wall and the sealant bonding portion. The second blocking wall includes a plurality of second blocking members arranged spaced away.

### TECHNICAL FIELD

The present disclosure relates to an array substrate and a method for manufacturing an array substrate, and a display device.

### BACKGROUND

A liquid crystal display controls luminance transmitted through a liquid crystal layer by controlling a rotation direction and a rotation angle of liquid crystal molecules, thereby displaying images of various grayscales. The liquid crystal display has advantages of high picture quality, small size, light weight, and the like, and is widely used in products such as mobile phones, notebook computers, televisions and displays.

Currently, an array substrate and a color film (CF) substrate of the liquid crystal display are generally provided with sealant to prevent leakage of liquid crystal and to connect the array substrate and the CF substrate. In addition, in order to arrange the liquid crystal molecules in a specific rotation direction, it is necessary to manufacture an alignment film on the array substrate and the CF substrate to limit alignment state of the liquid crystal molecules. A conventional method for manufacturing the alignment film is to coat a solution in which polymer compound of polyimide is dissolved on a surface of a substrate where the alignment film is to be made, and then perform alignment treatment on the polyimide solution to form the alignment film.

### SUMMARY

According to various embodiments, the present disclosure provides an array substrate and a method for manufacturing an array substrate, and a display device.

An array substrate includes an underlay substrate; a blocking wall disposed in a sealing area on the underlay substrate; and an alignment film disposed in a display area on the underlay substrate.

The blocking wall is located in the sealing area at inner side of a sealant bonding portion. The blocking wall is configured to prevent the alignment film in the display area from diffusing to the sealant bonding portion.

The blocking wall includes a first blocking wall and a second blocking wall. The first blocking wall includes a plurality of first blocking members arranged spaced away. The second blocking wall is located between the first blocking wall and the sealant bonding portion. The second blocking wall includes a plurality of second blocking members arranged spaced away.

The first blocking wall is configured to block the alignment film in at least a first flow direction. The second blocking wall is configured to block the alignment film in at least a second flow direction.

A method for manufacturing an array substrate is provided. The array substrate includes an underlay substrate, a blocking wall disposed in a sealing area on the underlay substrate, and an alignment film disposed in a display area on the underlay substrate. The method includes:

forming a common electrode metal on the underlay substrate;

forming a gate insulating layer on the common electrode metal;

forming a passivation layer is formed on the gate insulating layer; and

disposing the blocking wall on a common electrode metal area. An area of the common electrode metal corresponding to the passivation layer is the common electrode metal area. The blocking wall includes a first blocking wall and a second blocking wall. The first blocking wall includes a plurality of first blocking members arranged spaced away. The second blocking wall is located between the first blocking wall and a sealant bonding portion. The second blocking wall includes a plurality of second blocking members arranged spaced away. The first blocking wall is configured to block the alignment film in at least a first flow direction. The second blocking wall is configured to block the alignment film in at least a second flow direction.

A display device includes the array substrate as described above.

The details of at least an embodiment of the present disclosure will be presented with reference to the following drawings and description. Other characteristic and advantages of the present disclosure will be more apparent from the specification, drawings and claims.

### BRIEF DESCRIPTION OF THE DRAWINGS

For a better description and illustration of the embodiments and/or examples of this application, reference may be made to one or more accompanying drawings. Additional details or examples configured to describe the accompanying drawings should not be construed as limiting the scope of any one of the disclosed applications, the presently described embodiments and examples, and the best pattern of such applications as is presently understood

FIG. 1 is a schematic view showing an array substrate according to an embodiment.

FIG. 2 is a schematic view showing an array substrate according to another embodiment.

FIG. 3 is a schematic view showing an array substrate according to another embodiment.

FIG. 4 is a schematic view showing an array substrate according to another embodiment.

FIG. 5 is a schematic view showing an array substrate according to another embodiment.

FIG. 6 is a cross-sectional view showing an array substrate according to an embodiment.

FIG. 7 is a cross-sectional view showing an array substrate according to another embodiment.

FIG. 8 is a flowchart of a method for manufacturing an array substrate according to an embodiment.

### DETAILED DESCRIPTION OF THE EMBODIMENTS

Due to the fluidity of the liquid, the polyimide liquid easily diffuses to a sealant bonding portion in a sealing area, which affects the adhesion of the sealant, thereby affecting the connection between the array substrate and the CF substrate.

Embodiments of the disclosure are described more fully hereinafter with reference to the accompanying drawings. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

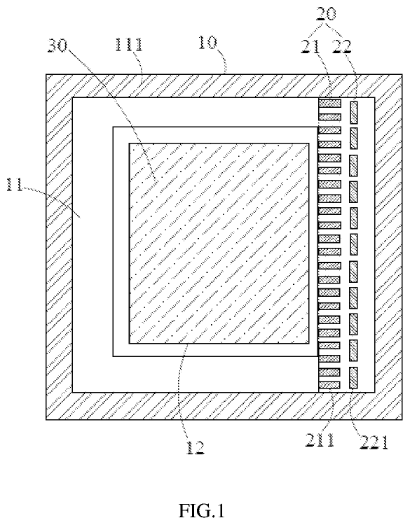

Referring to FIG. 1 to FIG. 4, which are schematic views showing array substrates according to embodiments. The array substrate includes an underlay substrate 10, a blocking wall 20 disposed in a sealing area 11 on the underlay substrate 10, and an alignment film 30 disposed in a display area 12 on the underlay substrate 10. The underlay substrate 10 may be a transparent substrate, and may specifically be a substrate made of a transparent material with certain ruggedness, such as glass or transparent resin.

The blocking wall 20 is located in the sealing area 11 at inner side of a sealant bonding portion 111. The blocking wall 20 is used to prevent the alignment film in the display area 12 from diffusing to the sealant bonding portion 111.

Specifically, the underlay substrate 10 includes the display area 12 and a non-display area surrounding the display area 12. The display area 12 is used for displaying images. The non-display area is a shading area to prevent backlight of a backlight module from transmitting through the non-display area, so as to ensure the display effect of a liquid crystal display panel. The non-display area includes the sealing area 11.

Specifically, the underlay substrate 10 includes a display area 12 and a non-display area surrounding the display area 12. The display area 12 is used for displaying images, and the non-display area is a shading area to prevent backlighting of the backlight module. It penetrates from the non-display area to ensure the display effect of the liquid crystal display panel. The non-display area includes a sealing area 11.

The blocking wall 20 includes a first blocking wall 21 and a second blocking wall 22. The first blocking wall 21 includes a plurality of first blocking members 211 arranged spaced away. The second blocking wall 22 is located between the first blocking wall 21 and the sealant bonding portion 111. The second blocking wall 22 includes a plurality of second blocking members 221 arranged spaced away.

The first blocking wall 21 is used to block the alignment film 30 in at least a first flow direction. The second blocking wall 22 is used to block the alignment film 30 in at least a second flow direction.

The first blocking wall 21 and the second blocking wall 22 are disposed in the sealing area 11 on the underlay substrate 10 at the inner side of the sealant bonding portion 111. The first blocking wall 21 includes the plurality of first blocking members 211 arranged spaced away. The second blocking wall 22 is located between the first blocking wall 21 and the sealant bonding portion 111. The second blocking wall 22 includes the plurality of second blocking members 221 arranged spaced away. The first blocking wall 21 can block the alignment film 30 in at least the first flow direction, thereby reducing flow speed of the alignment film 30. The second blocking wall 22 can block the alignment film 30 in at least the second flow direction, such that the second blocking wall 22 can prevent the alignment film 30 from diffusing to the sealant bonding position 111, avoiding reducing the adhesion of the sealant due to overlapping of the alignment film 30 and the sealant bonding portion 111. The first blocking wall 21 can also block a reflow of the alignment film 30.

In an embodiment, the first blocking member 211 and the second blocking member 221 are both baffles with a sheet-like structure. Blocking surfaces of the baffles are used to block in at least the first flow direction and at least the second flow direction. The first blocking member 211 and the second blocking member 221 having a sheet structure are easy to be manufactured, and the blocking surfaces thereof can effectively block the alignment film 30.

Referring to FIG. 1, the blocking surfaces of the baffles as the first blocking members 211 are parallel to a coating direction of the alignment film 30. The blocking surfaces of the baffles as the second blocking members 221 are perpendicular to the coating direction of the alignment film 30. The coating direction of the alignment film 30 is from the display area 12 to the sealing area 11. By providing the baffles as the first blocking members 211 parallel to the coating direction of the alignment film 30 and the baffles as the second blocking members 221 perpendicular to the coating direction of the alignment film 30, it is possible to block the diffusion of the alignment film 30 according to the coating direction of the alignment film 30.

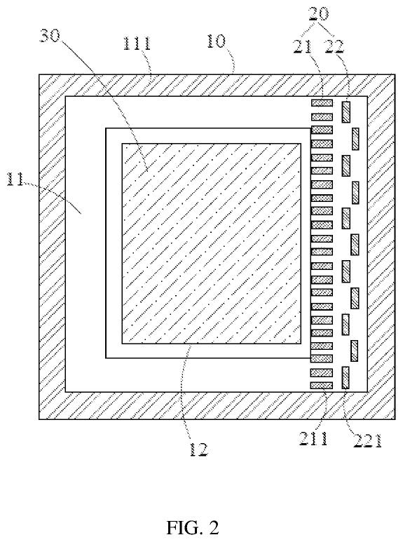

Please refer to FIG. 2, the first blocking members 211 are sequentially arranged spaced away along a first straight line perpendicular to the coating direction of the alignment film 30. The second blocking members 221 is divided into two rows, which are sequentially arranged spaced away along a second straight line and a third straight line that are perpendicular to the coating direction of the alignment film 30, respectively. Two adjacent second blocking members are located on the second straight line and the third straight line, respectively. Since there are gaps between the first blocking members 211 and between the second blocking members 221, the alignment film 30 can stay in the gaps and thus stop diffusing.

Further, the first blocking members 211 are evenly spaced, and the second blocking members 221 are evenly spaced, so that the alignment film 30 of which the reflow is blocked by the second blocking wall 22 can be distributed uniformly when reflowing to the display area 12, and thus the alignment film 30 is formed to have a uniform thickness.

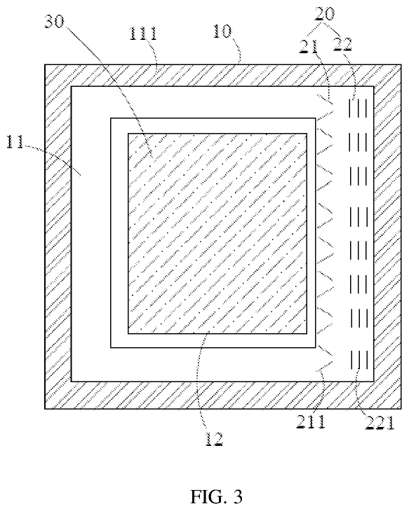

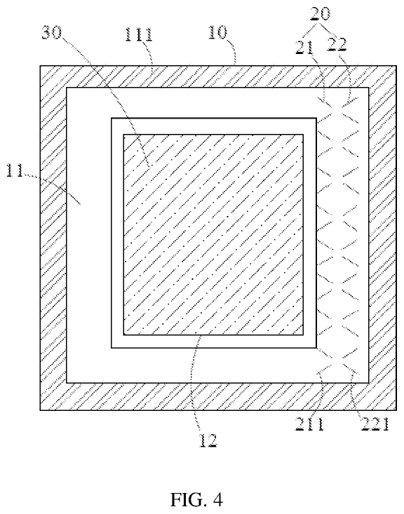

Referring to FIGS. 3 and 4, in an embodiment, the blocking surfaces of the baffles as the first blocking members 211 form a first preset angle with the coating direction of the alignment film 30. The blocking surfaces of the baffles as the second blocking members 221 form a second preset angle with the coating direction of the alignment film 30. The blocking surfaces as the baffles as the first blocking members 211 and the blocking surfaces of the baffles as the second blocking members 221 are set to form different angles with the coating direction of the alignment film 30 according to the actual needs, so that the alignment film 30 can be blocked according to actual needs.

In an embodiment, the first preset angle is greater than 0 degrees and less than 90 degrees, and the second preset angle is greater than 0 degrees and less than 90 degrees, such that the blocking wall 20 can better block the alignment film 30 and better prevent the alignment film 30 from reflowing.

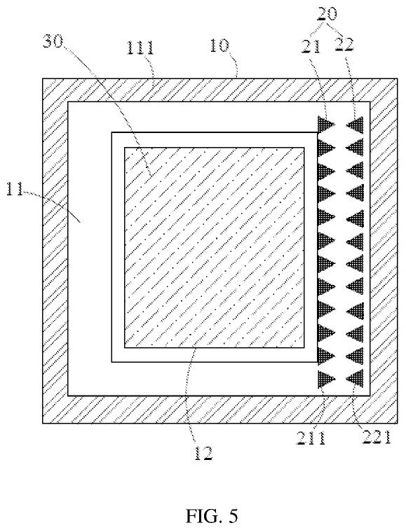

Referring to FIG. 5, the first blocking members 211 and the second blocking members 221 are both triangular prisms. Three cylindrical surfaces of the triangular prisms perpendicular to the underlay substrate 10 can be used to block in at least the first flow direction and at least the second flow direction. The first blocking members 211 and the second blocking members 221 are provided to have a triangular prism structure, which enables the blocking wall 20 to have a plurality of blocking surfaces, and thus have good blocking effect.

It should be noted that the first blocking members 211 and the second blocking members 221 may also have other structures and other arrangements, which are not limited herein.

In an embodiment, a height of the blocking member 211 is less than a height of the second blocking member 221, so that the blocking wall 20 forms a slope structure. When the alignment film 30 has less solution, the height of the first blocking wall 21 can just block the diffusion of the alignment film 30. When the alignment film 30 has a lot of solution, the alignment film 30 can either diffuse through the gaps of the first blocking member 211, or can go above the first blocking wall 21 and remain between the first blocking wall 21 and the second blocking wall 21, which can prevent the alignment film 30 from reflowing excessively, and avoid the problem of uneven display.

The first blocking member 211 and the second blocking member 221 can be made of a first metal layer or a second metal layer that is used to manufacture the array substrate. In this way, the first blocking wall 21 and the second blocking wall 22 can be manufactured along with the first metal layer or the second metal layer of the array substrate in the same manufacture procedure, which reduces manufacture procedure of the array substrate, and also makes the materials for the blocking wall easy to be obtained, saving costs. The first metal layer may be indium tin oxide, and the second metal layer may be copper or aluminum. The first blocking member 211 and the second blocking member 221 may also be made of non-metal.

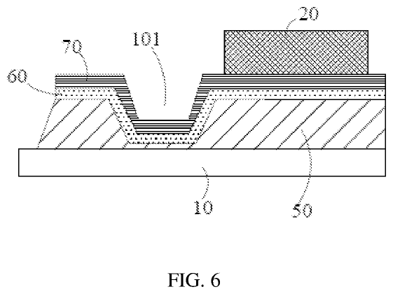

Referring to FIG. 6, which is a schematic diagram of an array substrate according to another embodiment of the present application. The array substrate includes an underlay substrate 10, a blocking wall 20 disposed in a sealing area 11 on the underlay substrate 10, and an alignment film 30 disposed in a display area 12 on the underlay substrate 10. The underlay substrate 10 may be a transparent substrate, and may specifically be a substrate made of a transparent material with certain ruggedness such as glass or transparent resin.

The blocking wall 20 is located in the sealing area 11 at inner side of the sealant bonding portion 111. The blocking wall 20 is used to prevent the alignment film in the display area 12 from diffusing to the sealant bonding portion 111.

The blocking wall 20 includes a first blocking wall 21 and a second blocking wall 22. The first blocking wall 21 includes a plurality of first blocking members 211 arranged spaced away. The second blocking wall 22 is located between the first blocking wall 21 and the sealant bonding portion 111. The second blocking wall 22 includes a plurality of second blocking members 221 arranged spaced away.

The first blocking wall 21 is used to block the alignment film 30 in at least a first flow direction. The second blocking wall 22 is used to block the alignment film 30 in at least a second flow direction.

A common electrode metal 50 is formed on the underlay substrate 10. A gate insulating layer 60 is formed on the common electrode metal 50. A passivation layer 70 is formed on the gate insulating layer 60. An area of the common electrode metal 50 corresponding to the passivation layer 70 is a common electrode metal 50 area. The blocking wall 20 is disposed on the common electrode metal 50 area. The sealing area 11 includes the common electrode metal area. There is no barrier that prevents the alignment film 30 from diffusing on the common electrode metal 50 area. Therefore, disposing the blocking wall 20 on the common electrode metal 50 area can effectively block the diffusion of the alignment film 30.

In an embodiment, a groove 101 is disposed on a surface of the underlay substrate 10 where the blocking wall 20 is provided. The groove 101 is located at inner side of the blocking wall 20. Further, the groove 101 is located on the common electrode metal 50 area. When the alignment film 30 is coated on the underlay substrate 10, the solution forming the alignment film 30 firstly diffuses to the groove 101, and then diffuses to the blocking wall 20 through the groove 101, thereby increasing the difficulty for the alignment film 30 to diffuse through the blocking wall 20 to overlap with the sealant bonding portion 111.

In an embodiment, the passivation layer 70 is provided with a through hole. The through hole and the gate insulating layer 60 enclose the groove 101. In other embodiments, both the passivation layer 70 and the gate insulating layer 60 are provided with through holes, and the through holes and the common electrode metal 50 enclose the groove 101. In other embodiments, the passivation layer 70, the gate insulating layer 60 and the common electrode metal 50 may all be provided with through holes, and the through holes and the underlay substrate 10 enclose the groove 101.

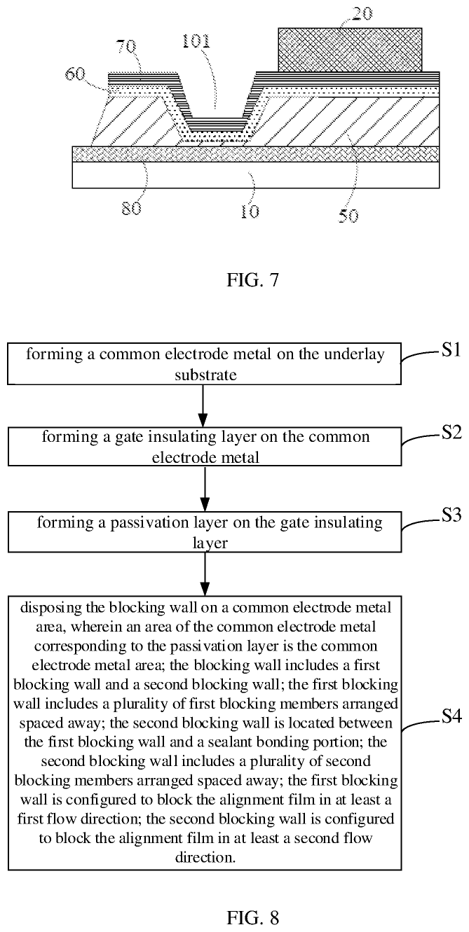

Referring to FIG. 7, when the array substrate is an array substrate in an advanced super dimension switch panel or an in-plane switching panel, the array substrate includes an underlay substrate 10, a blocking wall 20 disposed in a sealing area 11 on the underlay substrate 10, and an alignment film 30 disposed in a display area 12 on the underlay substrate 10. The underlay substrate 10 may be a transparent substrate, and may specifically be a substrate made of a transparent material with certain ruggedness, such as glass or transparent resin. An indium tin oxide layer 80 is formed on the underlay substrate 10. The indium tin oxide layer 80 is located between the underlay substrate 10 and the common electrode metal 50. That is, the common electrode metal 50 is formed on the indium tin oxide layer 80. A gate insulating layer 60 formed on the common electrode metal 50. A passivation layer 70 is formed on the gate insulating layer 60. An area of the common electrode metal 50 corresponding to the passivation layer 70 is a common electrode metal 50 area. The blocking wall 20 is disposed on the common electrode metal 50 area.

It should be noted that the array substrate according to the embodiments of the present application may be applicable to the production of ADS type, IPS type, IN type and other types of liquid crystal display devices. ADS technology uses parallel electric field generated by an edge of a pixel electrode in the same plane and a longitudinal electric field generated between a pixel electrode layer and a common electrode layer to form a multi-dimensional electric field, so that all oriented liquid crystal molecules between pixel electrodes and directly above the electrodes in a liquid crystal cell can rotate for switch, thereby improving the working efficiency of the plane oriented liquid crystal and increasing the light transmittance.

In the array substrate according to the present application, a first blocking wall 21 and a second blocking wall 22 are disposed in the sealing area 11 at inner side of a sealant bonding portion 111 on the underlay substrate 10. The first blocking wall 21 includes a plurality of first blocking members 211 arranged spaced away. The second blocking wall 22 is located between the first blocking wall 21 and the sealant bonding portion 111. The second blocking wall 22 includes a plurality of second blocking members 221 arranged spaced away. The first blocking wall 21 can block the alignment film 30 in at least the first flow direction, thereby reducing flow speed of the alignment film 30. The second blocking wall 22 can block the alignment film 30 in at least the second flow direction, such that the second blocking wall 22 can prevent the alignment film 30 from diffusing to the sealant bonding position 111, avoiding reducing the adhesion of the sealant due to overlapping of the alignment film 30 and the sealant bonding portion 111. The first blocking wall 21 can also block a reflow of the alignment film 30.

Referring to FIG. 8, the preset application further provides a method for manufacturing an array substrate. The array substrate includes an underlay substrate 10, a blocking wall 20 disposed in a sealing area 11 on the underlay substrate 10, and an alignment film 30 disposed in a display area 12 on the underlay substrate 10. The underlay substrate 10 may be a transparent substrate, and may specifically be a substrate made of a transparent material with certain ruggedness, such as glass or transparent resin. The method flow includes the following steps.

Step S1, a common electrode metal 50 is formed on the underlay substrate 10.

The formation of the common electrode metal 50 on the underlay substrate 10 may include forming the common electrode metal 50 having a groove 101 on the underlay substrate 10. The common electrode metal 50 can be made of tungsten, titanium, molybdenum, aluminum, neodymium, aluminum nickel alloy, molybdenum tungsten alloy, chromium, or copper, or a combination thereof.

Specifically, the common electrode metal 50 with a flat surface can be formed on the underlay substrate 10 by coating, deposition, sputtering, or the like, and then a mask with specific patterns is used for exposure, development, etching and photoresist stripping, so as to form the common electrode metal 50 having the groove 101.

Step S2, a gate insulating layer 60 is formed on the common electrode metal 50.

The gate insulating layer 60 can be formed on a surface of the common electrode metal 50 by coating, deposition, sputtering, or the like. For example, a layer of organic resin material with a certain thickness is coated on the surface of the common electrode metal 50 to form the gate insulating layer 60.

The gate insulating layer 60 can also be made of oxides, nitrides or oxygen-nitrogen compounds, and the corresponding reactive gas can be a mixed gas of SiH₄, NH₃, and N₂ or a mixed gas of SiH₂Cl₂, NH₃, and N₂.

It should be noted that since the groove 101 is formed on the common electrode metal 50, after the gate insulating layer 60 is formed, an area of the gate insulating layer 60 corresponding to the groove 101 of the common electrode metal 50 is also formed with the groove 101.

Step S3, a passivation layer 70 is formed on the gate insulating layer 60.

The passivation layer 70 may be formed on the gate insulating layer 60 by coating, deposition, sputtering, or the like. For example, a layer of silicide with a certain thickness is sputtered on a surface of the gate insulating layer 60 to form the passivation layer 70.

The passivation layer 70 can be made of oxides, nitrides or oxygen-nitrogen compounds, and the corresponding reactive gas can be a mixed gas of SiH₄, NH₃, and N₂ or a mixed gas of SiH₂Cl₂, NH₃, and N₂.

It should be noted that, corresponding to the groove 101 formed on the common electrode metal 50 and the gate insulating layer 60, the passivation layer 70 is also formed with the groove 101.

Step S4, the blocking wall 20 is disposed on a common electrode metal 50 area. An area of the common electrode metal 50 corresponding to the passivation layer 70 is the common electrode metal 50 area. The blocking wall 20 includes a first blocking wall 21 and a second blocking wall 22. The first blocking wall 21 includes a plurality of first blocking members 211 arranged spaced away. The second blocking wall 22 is located between the first blocking wall 21 and a sealant bonding portion 111. The second blocking wall 22 includes a plurality of second blocking members 221 arranged spaced away. The first blocking wall 21 is used to block the alignment film 30 in at least a first flow direction. The second blocking wall 22 is used to block the alignment film 30 in at least a second flow direction.

In an embodiment, before the step S1, the method further includes forming an indium tin oxide layer 80 on the underlay substrate 10.

Thicknesses of the indium tin oxide layer 80, the gate insulating layer 60 and the passivation layer 70 can be set according to actual needs, and which are not limited herein.

In summary, in the method for manufacturing the array substrate according to the embodiment of the present application, the first blocking wall 21 and the second blocking wall 22 are disposed in the sealing area 11 at inner side of the sealant bonding portion 111 on the underlay substrate 10. The first blocking wall 21 includes the plurality of first blocking members 211 arranged spaced away. The second blocking wall 22 is located between the first blocking wall 21 and the sealant bonding portion 111. The second blocking wall 22 includes the plurality of second blocking members 221 arranged spaced away. The first blocking wall 21 can block the alignment film 30 in at least the first flow direction, thereby reducing flow speed of the alignment film 30. The second blocking wall 22 can block the alignment film 30 in at least the second flow direction, such that the second blocking wall 22 can prevent the alignment film 30 from diffusing to the sealant bonding position 111, avoiding reducing the adhesion of the sealant due to overlapping of the alignment film 30 and the sealant bonding portion 111. The first blocking wall 21 can also block a reflow of the alignment film 30.

An embodiment of the present application further provides a display device. The display device includes the array substrate according to any one of the above embodiments. The display device further includes a color film (CF) substrate and a liquid crystal layer disposed between the array substrate and the CF substrate. The display device may be any product or component with display function, such as liquid crystal panel, electronic paper, organic light emitting diode panel, mobile phone, tablet computer, television, display, notebook computer, digital photo frame, or navigator.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

Although the disclosure is illustrated and described herein with reference to specific embodiments, the disclosure is not intended to be limited to the details shown. Rather, various modifications may be made in the details within the scope and range of equivalents of the claims and without departing from the disclosure. Therefore, the protection scope of the present disclosure shall be subject to the protection scope of the appended claims.

1. An array substrate, comprising:
an underlay substrate;
a blocking wall disposed in a sealing area on the underlay substrate; and
an alignment film disposed in a display area on the underlay substrate;
wherein the blocking wall is located in the sealing area at inner side of a sealant bonding portion, the blocking wall is configured to prevent the alignment film in the display area from diffusing to the sealant bonding portion;
the blocking wall comprises a first blocking wall and a second blocking wall, the first blocking wall comprises a plurality of first blocking members arranged spaced away, the second blocking wall is located between the first blocking wall and the sealant bonding portion, the second blocking wall comprises a plurality of second blocking members arranged spaced away;
the first blocking wall is configured to block the alignment film in at least a first flow direction, and the second blocking wall is configured to block the alignment film in at least a second flow direction.

2. The array substrate according to claim 1, wherein the first blocking member and the second blocking member are both baffles with a sheet-like structure, and blocking surfaces of the baffles are configured to block in at least the first flow direction and at least the second flow direction.

3. The array substrate according to claim 2, wherein the blocking surfaces of the baffles as the first blocking members are parallel to a coating direction of the alignment film, and the blocking surfaces of the baffles as the second blocking members are perpendicular to the coating direction of the alignment film; and wherein the coating direction of the alignment film is from the display area to the sealing area.

4. The array substrate according to claim 3, wherein the first blocking members are sequentially arranged spaced away along a first straight line perpendicular to the coating direction of the alignment film; the second blocking members is divided into two rows, which are sequentially arranged spaced away along a second straight line and a third straight line that are perpendicular to the coating direction of the alignment film, respectively; and two adjacent second blocking members are located on the second straight line and the third straight line, respectively.

5. The array substrate according to claim 2, wherein the blocking surfaces of the baffles as the first blocking members form a first preset angle with a coating direction of the alignment film, and the blocking surfaces of the baffles as the second blocking members form a second preset angle with the coating direction of the alignment film.

6. The array substrate according to claim 5, wherein the first preset angle is greater than 0 degrees and less than 90 degrees, and the second preset angle is greater than 0 degrees and less than 90 degrees.

7. The array substrate according to claim 1, wherein the first blocking members and the second blocking members are both triangular prisms, and three cylindrical surfaces of the triangular prisms perpendicular to the underlay substrate is capable of blocking in at least the first flow direction and at least the second flow direction.

8. The array substrate according to claim 1, wherein a common electrode metal is formed on the underlay substrate; a gate insulating layer is formed on the common electrode metal; a passivation layer is formed on the gate insulating layer; an area of the common electrode metal corresponding to the passivation layer is a common electrode metal area; the blocking wall is disposed on the common electrode metal area; and the sealing area comprises the common electrode metal area.

9. A method for manufacturing an array substrate, the array substrate comprising an underlay substrate, a blocking wall disposed in a sealing area on the underlay substrate, and an alignment film disposed in a display area on the underlay substrate, the method comprising:
forming a common electrode metal on the underlay substrate;
forming a gate insulating layer on the common electrode metal;
forming a passivation layer is formed on the gate insulating layer; and
disposing the blocking wall on a common electrode metal area;
wherein an area of the common electrode metal corresponding to the passivation layer is the common electrode metal area;
the blocking wall comprises a first blocking wall and a second blocking wall; the first blocking wall comprises a plurality of first blocking members arranged spaced away; the second blocking wall is located between the first blocking wall and a sealant bonding portion; the second blocking wall comprises a plurality of second blocking members arranged spaced away; the first blocking wall is configured to block the alignment film in at least a first flow direction; and the second blocking wall is configured to block the alignment film in at least a second flow direction.

10. A display device, comprising an array substrate according to claim 1.

11. The display device according to claim 10, wherein the first blocking member and the second blocking member are both baffles with a sheet-like structure, and blocking surfaces of the baffles are configured to block in at least the first flow direction and at least the second flow direction.

12. The display device according to claim 11, wherein the blocking surfaces of the baffles as the first blocking members are parallel to a coating direction of the alignment film, and the blocking surfaces of the baffles as the second blocking members are perpendicular to the coating direction of the alignment film; and wherein the coating direction of the alignment film is from the display area to the sealing area.

13. The display device according to claim 12, wherein the first blocking members are sequentially arranged spaced away along a first straight line perpendicular to the coating direction of the alignment film; the second blocking members is divided into two rows, which are sequentially arranged spaced away along a second straight line and a third straight line that are perpendicular to the coating direction of the alignment film, respectively; and two adjacent members are located on the second straight line and the third straight line, respectively.

14. The display device according to claim 11, wherein the blocking surfaces of the baffles as the first blocking members form a first preset angle with a coating direction of the alignment film, and the blocking surfaces of the baffles as the second blocking members form a second preset angle with the coating direction of the alignment film.

15. The display device according to claim 14, wherein the first preset angle is greater than 0 degrees and less than 90 degrees, and the second preset angle is greater than 0 degrees and less than 90 degrees.

16. The method according to claim 9, wherein the forming the common electrode metal on the underlay substrate comprises:
forming the common electrode metal having a groove on the underlay substrate.

17. The method according to claim 16, wherein the common electrode metal 50 is made of tungsten, titanium, molybdenum, aluminum, neodymium, aluminum nickel alloy, molybdenum tungsten alloy, chromium, copper, or a combination thereof.

18. The method according to claim 9, wherein the gate insulating layer is made of oxides, nitrides or oxygen-nitrogen compounds, and a corresponding reactive gas is a mixed gas of SiH4, NH3, and N2 or a mixed gas of SiH2Cl2, NH3, and N2.

19. The method according to claim 9, wherein the passivation layer is made of oxides, nitrides or oxygen-nitrogen compounds, and a corresponding reactive gas is a mixed gas of SiH4, NH3, and N2 or a mixed gas of SiH2Cl2, NH3, and N2.

20. The method according to claim 9, prior to the forming the common electrode metal on the underlay substrate, the method further comprising forming an indium tin oxide layer on the underlay substrate.
